(19) United States
(12) Patent Application Publication
(10) Pub. No.: US 2012/0182385 A1
(43) Pub. Date: Jul. 19, 2012

(54) STEREOPHONIC SOUND GENERATING APPARATUS AND STEREOPHONIC SOUND GENERATING METHOD

(75) Inventor: Takeshi Kanamori, Tokyo (JP)

(73) Assignee: Kabushiki Kaisha Toshiba, Tokyo (JP)

(21) Appl. No.: 13/235,814

(22) Filed: Sep. 19, 2011

(30) Foreign Application Priority Data
Jan. 19, 2011 (JP) 2011-008866

(51) Int. Cl. H04N 13/00

(52) U.S. Cl. 348/42; 348/E13.001

(57) ABSTRACT

A stereophonic sound generating apparatus of an embodiment includes a depth vector detecting unit, a motion vector detecting unit, an area dividing unit which divides a frame into a plurality of areas on the basis of motion vectors detected by the motion vector detecting unit, a depth vector average calculating unit, a voice processing unit which divides a frequency spectrum extracted from a voice signal into a plurality of frequency components, an associating unit which associates the plurality of areas divided by the area dividing unit with the plurality of frequency components divided by the voice processing unit, and a voice source identifying unit which identifies a source of a voice of a corresponding frequency component from the plurality of frequency components on the basis of the average of the depth vectors calculated for each of the areas by the depth vector average calculating unit.

### CROSS-REFERENCE TO RELATED APPLICATION

This application is based upon and claims the benefit of priority from the prior Japanese Patent Application No. 2011-8866 filed on Jan. 19, 2011; the entire contents of which are incorporated herein by reference.

### FIELD

An embodiment described herein relates generally to a stereophonic sound generating apparatus and a stereophonic sound generating method.

### BACKGROUND

In recent years, television broadcast of three-dimensional (3D) video has started, and stereophonic sound generating apparatuses for generating stereophonic sound from such 3D video have been proposed. The stereophonic sound generating apparatuses generate stereophonic sound from motion vectors of 3D video.

Accordingly, because conventional stereophonic sound generating apparatuses generate stereophonic sound from object motions in right and left directions in 3D video, the accuracy of stereophonic sound in a depth direction disadvantageously has been low.

### BRIEF DESCRIPTION OF THE DRAWINGS

FIG. 1 is a block diagram illustrating a configuration of a stereophonic sound generating apparatus according to an embodiment;

FIG. 2 is a diagram for explaining a 3D video signal;

FIG. 3 is a diagram for explaining motion vectors and depth vectors;

FIG. 4 is a diagram for explaining association information between information of divided areas and information of frequency components; and

FIG. 5 is an algorithm showing an example of a flow of stereophonic sound generating processing.

### DETAILED DESCRIPTION

A stereophonic sound generating apparatus of an embodiment includes a depth vector detecting unit, a motion vector detecting unit, an area dividing unit, a depth vector average calculating unit, a voice processing unit, an associating unit, and a voice source identifying unit. The depth vector detecting unit detects depth vectors in three-dimensional video from a three-dimensional video signal. The motion vector detecting unit detects motion vectors in the three-dimensional video from the three-dimensional video signal. The area dividing unit divides a frame into a plurality of areas on the basis of the motion vectors detected by the motion vector detecting unit. The depth vector average calculating unit calculates an average of the depth vectors for each of the areas and associates the averages with the areas. The voice processing unit divides a frequency spectrum extracted from a voice signal into a plurality of frequency components. The associating unit associates the plurality of areas divided by the area dividing unit with the plurality of frequency components divided by the voice processing unit. The voice source identifying unit identifies a source of voice of a corresponding frequency component from the plurality of frequency components on the basis of the average of the depth vectors calculated for each of the areas by the depth vector average calculating unit.

Now, the stereophonic sound generating apparatus of the embodiment will be described in detail with reference to the drawings.

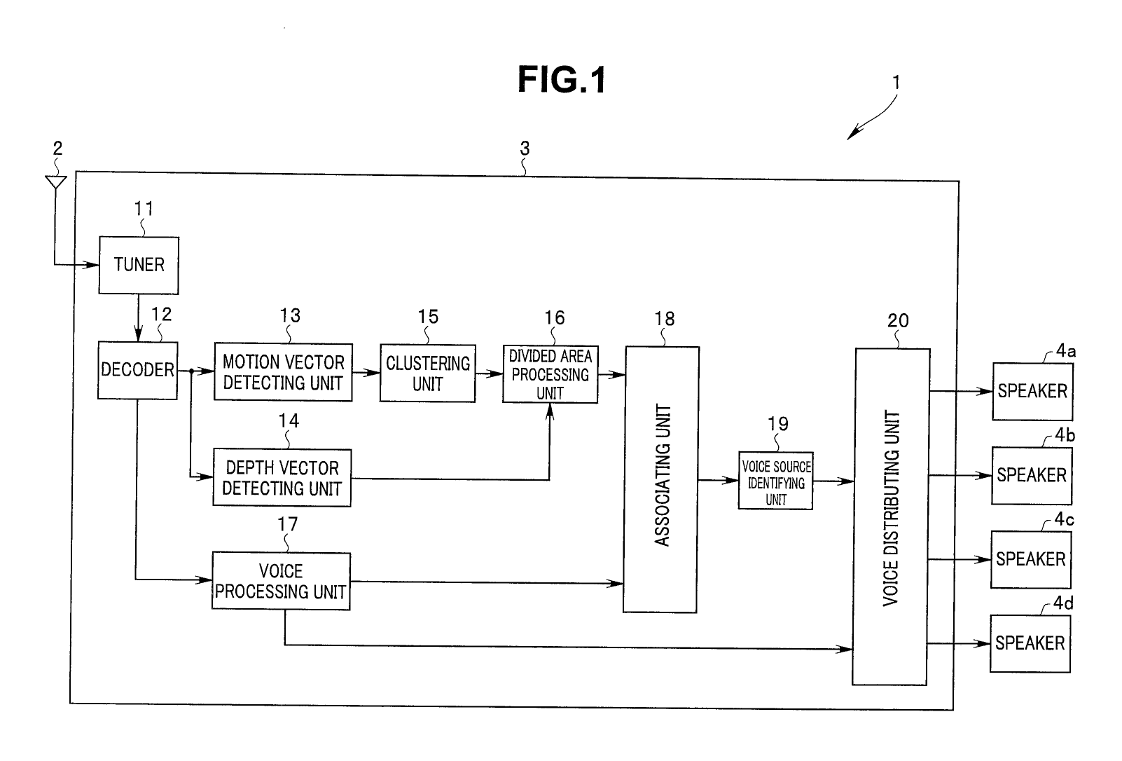

First, on the basis of FIG. 1, a configuration of the stereophonic sound generating apparatus according to the embodiment will be described.

FIG. 1 is a block diagram illustrating the configuration of the stereophonic sound generating apparatus according to the embodiment.

As illustrated in FIG. 1, a stereophonic sound generating apparatus 1 is, for example, a television device that displays 3D video, and includes an antenna 2, a television device main body 3, and a plurality of (in the embodiment, four) speakers 4a to 4d. It should be noted that the stereophonic sound generating apparatus 1 will be described as a television device that displays 3D video, but for example, the stereophonic sound generating apparatus 1 may be a playback device such as a DVD player that plays 3D video recorded on a recording medium.

For example, the speakers 4a to 4d as voice outputting devices are each placed in the following manner: the speaker 4a is placed in front of a viewer on the right, the speaker 4b is placed in front of the viewer on the left, the speaker 4c is placed behind the viewer on the right, the speaker 4d is placed behind the viewer on the left. It should be noted that the placements of the speakers 4a to 4d are not limited thereto. In addition, the number of the speakers is not limited to four.

The television device main body 3 includes a tuner 11, a decoder 12, a motion vector detecting unit 13, a depth vector detecting unit 14, a clustering unit 15, a divided area processing unit 16, a voice processing unit 17, an associating unit 18, a voice source identifying unit 19, and a voice distributing unit 20.

The antenna 2 receives digital broadcasting signals including 3D video signals and voice signals, and supplies the received digital broadcasting signals to the tuner 11.

The tuner 11 tunes in to a channel designated by a user from the supplied digital broadcasting signals and outputs the digital broadcasting signal to the decoder 12.

The decoder 12 decodes the input digital broadcasting signal and generates a 3D video signal for video displaying and a voice signal for voice outputting. The decoder 12 outputs the generated 3D video signal to the motion vector detecting unit 13 and the depth vector detecting unit 14 and outputs the voice signal to the voice processing unit 17. The voice signal may be monaural or stereo. Further, the 3D video signal generated by the decoder 12 is video-processed by a video processing unit (not shown) and then displayed on a displaying unit (not shown).

The 3D video signal will now be described.

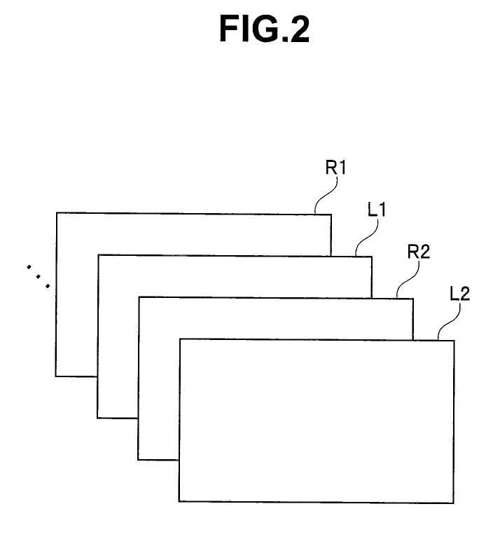

FIG. 2 is a diagram for explaining a 3D video signal.

As illustrated in FIG. 2, the 3D video signal generated by the decoder 12 is composed of frames for right eye and frames for left eye that are alternately layered in the following way: a frame for right eye R1, a frame for left eye L1, a frame for right eye R2, and a frame for left eye L2. A plurality of, for example, 30 frames for right eye and 30 frames for left eye compose one second of video. It should be noted that in the description, the number of frames for right eye and the number of frames for left eye that compose one second of video are each 30 as an example, but the numbers vary depending on a standard and are not limited to 30. In the embodiment, the frame for right eye R2 and the frame for left eye L2 are current frames and the frame for right eye R1 and the frame for left eye L1 are frames one frame earlier.

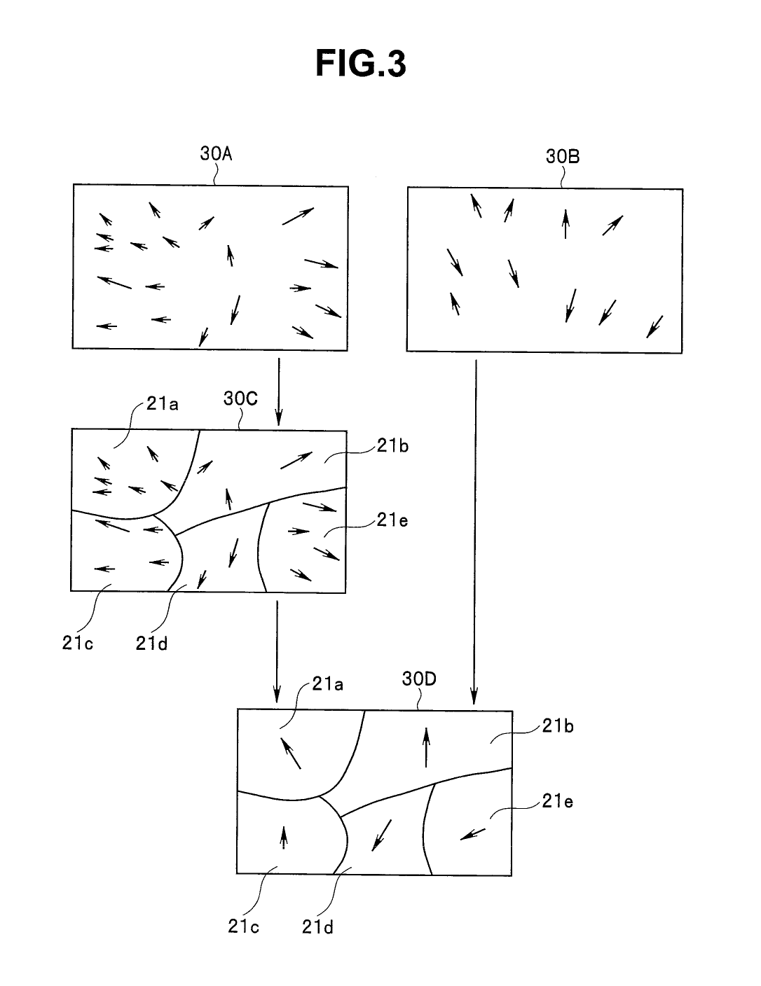

FIG. 3 is a diagram for explaining motion vectors and depth vectors.

The motion vector detecting unit 13 calculates a difference between a pixel value at coordinates of the current frame for right eye R2 and a pixel value at the same coordinates of the frame for right eye R1, which is a frame for right eye one frame earlier, to detect motion vectors shown in a frame 30A. It should be noted that the motion vector detecting unit 13 may calculate a difference between a pixel value at coordinates of the current frame for left eye L2 and a pixel value at the same coordinates of the frame for left eye L1, which is a frame for left eye one frame earlier, to detect motion vectors. Then, the motion vector detecting unit 13 outputs information of the detected motion vectors to the clustering unit 15.

Now, it is assumed that a pixel value with the greater magnitude of a motion vector corresponds to an object with the greater motion. It should be noted that the motion vector detecting unit 13 calculates a difference between the current frame for right eye R2 and the frame for right eye R1, which is a frame one frame earlier, to detect motion vectors, but the motion vector detecting unit 13 may calculate a difference between the current frame for right eye R2 and a frame for right eye that is a frame two or more frames earlier, to detect motion vectors. That is, because sometimes a great motion may not be detected from a difference between adjacent frames, a difference between frames having a few frames therebetween is calculated to detect a great motion.

The depth vector detecting unit 14 calculates a difference between a pixel value at coordinates of the current frame for right eye R2 and a pixel value at the same coordinates of the current frame for left eye L2 to detect depth vectors shown in a frame 30B. Then, the depth vector detecting unit 14 outputs information of the detected depth vectors to the divided area processing unit 16. Now, it is assumed that a pixel with the greater magnitude of a depth vector corresponds to the deeper or the shallower object.

The clustering unit 15 as an area dividing unit performs clustering on the basis of the information of the motion vectors detected by the motion vector detecting unit 13 and divides the frame into a plurality of areas each of which is composed of a part including similar vectors. For example, in an example of a frame 30C, the clustering unit 15 divides the frame into five areas 21a to 21e each of which is composed of a part including similar motion vectors. For example, the division can be performed by a K-means method or the like, which is a clustering method. The clustering unit 15 outputs information of the frame divided into the areas 21a to 21e to the divided area processing unit 16. In the processing of the clustering unit 15, it is assumed that one object displayed in a frame moves in one direction. That is, it is supposed that clustering based on information of motion vectors can divide a frame into areas of objects being displayed in the frame.

The divided area processing unit 16 as a depth vector average calculating unit calculates an average of the depth vectors detected by the depth vector detecting unit 14 for each of the areas 21a to 21e of the frame divided by the clustering unit 15. Thereby, as shown in a frame 30D, each of the calculated averages of the depth vectors is associated with each of the areas 21a to 21e.

Also, the divided area processing unit 16 arranges the areas 21a to 21e of the frame divided by the clustering unit 15 in descending order of area size of the divided areas 21a to 21e. The divided area processing unit 16 outputs information of the divided areas 21a to 21e arranged in descending order of area size to the associating unit 18.

The voice processing unit 17 performs Fourier transformation on the voice signal input from the decoder 12 to extract a frequency spectrum. The voice processing unit 17 outputs the extracted frequency spectrum to the voice distributing unit 20. Also, the voice processing unit 17 divides the extracted frequency spectrum into a plurality of frequency components and integrates the divided plurality of frequency components to calculate spectrum strengths of the plurality of frequency components. Then, the voice processing unit 17 arranges the divided frequency components in descending order of spectrum strength to output information of the frequency components arranged in descending order of spectrum strength to the associating unit 18.

The associating unit 18 associates the information of the divided areas 21a to 21e arranged in descending order of area size with the information of the frequency components arranged in descending order of spectrum strength. The associating unit 18 outputs association information obtained by the association to the voice source identifying unit 19. In the processing of the associating unit 18, it is assumed that the larger area (the larger object displayed in a frame) gives the louder sound (a frequency component with the greater spectrum strength).

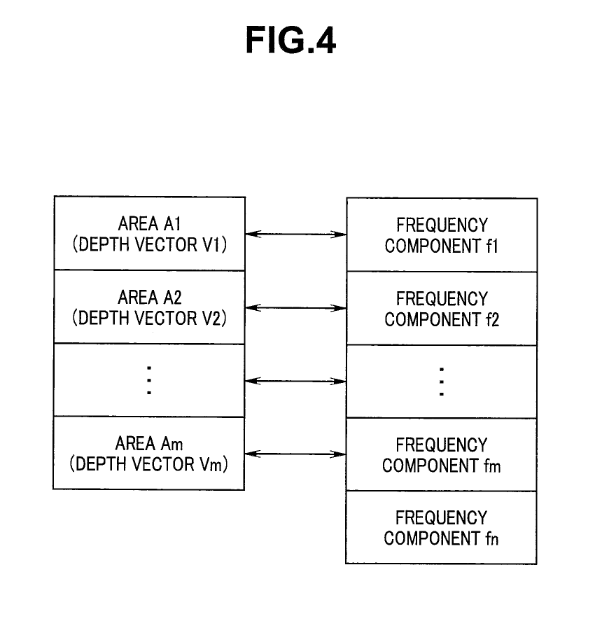

FIG. 4 is a diagram for explaining association information between information of divided areas and information of frequency components.

In an example of FIG. 4, divided areas are composed of areas A1 to Am, and arranged in descending order of area size: the areas A1, A2, . . . , and Am. It should be noted that depth vectors V1 to Vm, each of which is averaged for each area by the divided area processing unit 16, are associated with the areas A1 to Am.

Frequency components are composed of frequency components f1 to fn, and arranged in descending order of spectrum strength: the frequency components f1, f2, . . . , and fn. The area A1 having the largest divided area size is associated with the frequency component f1 having the greatest spectrum strength. The second and subsequent areas and frequency components are also associated with each other in the same manner.

It should be noted that the frequency component fn is not associated with a divided area. It is because the number of areas divided by the clustering unit 15 varies depending upon the similarity of the detected motion vectors and the number of divided areas does not necessarily correspond with the number of frequency components.

The voice source identifying unit 19 generates voice source information for identifying which of the speakers 4a to 4d outputs a voice of a corresponding frequency component based on the association information from the associating unit 18. In particular, the voice source identifying unit 19 identifies which of the speakers 4a to 4d outputs a voice of a corresponding frequency component on the basis of a depth vector averaged in a divided area. For example, in the example of FIG. 4, the voice source identifying unit 19 identifies which of the speakers 4a to 4d outputs a voice of the frequency component f1 on the basis of information of the depth vector V1 in the area A1. The voice source identifying unit 19 outputs the generated voice source information to the voice distributing unit 20.

The voice distributing unit 20 performs inverse Fourier transformation on the frequency spectrums from the voice processing unit 17 to extract voice signals and distributes, based on the voice source information from the voice source identifying unit 19, the voices of the frequency components f1 to fm corresponding to the depth vectors V1 to Vm so that each voice is output from appropriate one of the speakers 4a to 4d. Thereby, the speakers 4a to 4d output stereophonic voice extracted from 3D video signals.

Next, an operation of the stereophonic sound generating apparatus 1 having such a configuration will be described.

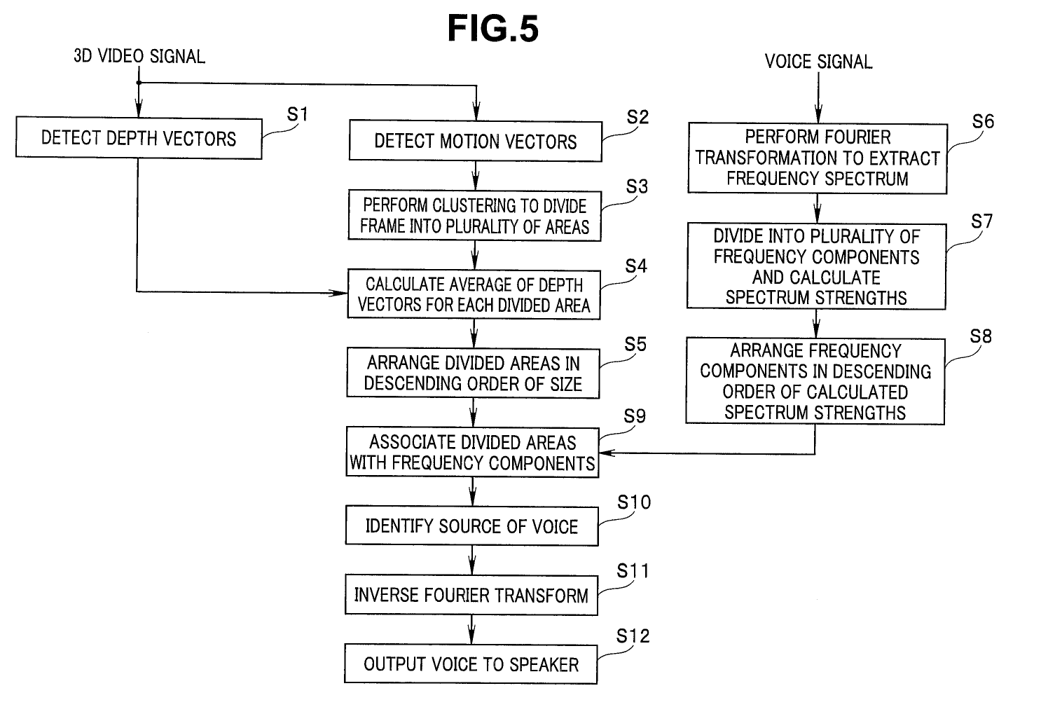

FIG. 5 is an algorithm showing an example of a flow of the stereophonic sound generating processing.

First, depth vectors are detected from a 3D video signal (step S1). The detected depth vectors are supplied to step S4. Motion vectors are detected from the 3D video signal (step S2). Clustering is performed on the basis of the detected motion vectors and a frame is divided into a plurality of areas (step S3). An average of depth vectors for each divided area is calculated (step S4). The divided areas are arranged in descending order of area size (step S5).

Next, Fourier transformation is performed on the voice signal to extract a frequency spectrum (step S6). The frequency spectrum is divided into a plurality of frequency components and spectrum strengths are calculated (step S7). The frequency components are arranged in descending order of the calculated spectrum strength (step S8).

The divided areas arranged in descending order of area size are associated with the frequency components arranged in descending order of spectrum strength (step S9). A source of the voice is identified on the basis of information of the depth vectors calculated for each divided area (step S10). Inverse Fourier transformation is performed on the frequency spectrum (step S11), and the voice is output from corresponding one of the speakers 4a to 4d (step S12). Then, the processing proceeds to end.

It should be noted that the steps of the algorithm shown in FIG. 5 may be executed in different order, some of the steps may be executed at the same time, or the steps may be executed in different order every time, unless such modifications are contrary to the nature of the algorithm.

Thus, according to the stereophonic sound generating apparatus 1 of the embodiment, clustering based on detected motion vectors divides a frame into a plurality of areas and a source of a voice is identified based on information of depth vectors calculated for each divided area, and thereby a stereophonic sound can be generated with higher accuracy.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A stereophonic sound generating apparatus comprising:
a depth vector detecting unit configured to detect depth vectors of three-dimensional video from a three-dimensional video signal;
a motion vector detecting unit configured to detect motion vectors of the three-dimensional video from the three-dimensional video signal;
an area dividing unit configured to divide a frame into a plurality of areas on the basis of the motion vectors detected by the motion vector detecting unit;
a depth vector average calculating unit configured to calculate an average of the depth vectors for each of the areas and associate the averages with the areas;
a voice processing unit configured to divide a frequency spectrum extracted from a voice signal into a plurality of frequency components;
an associating unit configured to associate the plurality of areas divided by the area dividing unit with the plurality of frequency components divided by the voice processing unit; and
a voice source identifying unit configured to identify a source of a voice of a corresponding frequency component from the plurality of frequency components on the basis of the average of the depth vectors for each of the areas calculated by the depth vector average calculating unit.

2. The stereophonic sound generating apparatus according to claim 1, wherein
the associating unit associates the plurality of areas arranged in descending order of area size with the plurality of frequency components arranged in descending order of spectrum strength.

3. The stereophonic sound generating apparatus according to claim 2, wherein
the area dividing unit divides the frame into the plurality of areas by a K-means method.

4. The stereophonic sound generating apparatus according to claim 1, wherein
the depth vector detecting unit calculates a difference between a pixel value at coordinates of a current frame for right eye and a pixel value at the same coordinates of a current frame for left eye to detect the depth vectors.

5. The stereophonic sound generating apparatus according to claim 4, wherein
the motion vector detecting unit calculates a difference between a pixel value at coordinates of the current frame for right eye or for left eye and a pixel value at the same coordinates in a frame for right eye or for left eye that is one or more frames earlier to detect the motion vectors.

6. A stereophonic sound generating method comprising:
detecting depth vectors of three-dimensional video from a three-dimensional video signal;
detecting motion vectors of the three-dimensional video from the three-dimensional video signal;
dividing a frame into a plurality of areas on the basis of the detected motion vectors;
calculating an average of the depth vectors for each of the areas and associating the averages with the areas;
dividing a frequency spectrum extracted from a voice signal into a plurality of frequency components;
associating the plurality of divided areas with the plurality of divided frequency components; and
identifying a source of a voice of a corresponding frequency component from the plurality of frequency components on the basis of the average of the depth vectors calculated for each of the areas.

7. The stereophonic sound generating method according to claim 6, further comprising
associating the plurality of areas arranged in descending order of area size with the plurality of frequency components arranged in descending order of spectrum strength.

8. The stereophonic sound generating method according to claim 7, further comprising
dividing the frame into the plurality of areas by a K-means method.

9. The stereophonic sound generating method according to claim 6, further comprising
calculating a difference between a pixel value at coordinates of a current frame for right eye and a pixel value at the same coordinates of a current frame for left eye to detect the depth vectors.

10. The stereophonic sound generating method according to claim 9, further comprising
calculating a difference between a pixel value at coordinates of the current frame for right eye or for left eye and a pixel value at the same coordinates in a frame for right eye or for left eye that is one or more frames earlier to detect the motion vectors.

11. A television device comprising:
a depth vector detecting unit configured to detect depth vectors of three-dimensional video from a three-dimensional video signal;
a motion vector detecting unit configured to detect motion vectors of the three-dimensional video from the three-dimensional video signal;
an area dividing unit configured to divide a frame into a plurality of areas on the basis of the motion vectors detected by the motion vector detecting unit;
a depth vector average calculating unit configured to calculate an average of the depth vectors for each of the areas and associate the averages with the areas;
a voice processing unit configured to divide a frequency spectrum extracted from a voice signal into a plurality of frequency components;
an associating unit configured to associate the plurality of areas divided by the area dividing unit with the plurality of frequency components divided by the voice processing unit;
a voice source identifying unit configured to identify a source of a voice of a corresponding frequency component from the plurality of frequency components on the basis of the average of the depth vectors for each of the areas calculated by the depth vector average calculating unit;
a plurality of voice outputting devices each of which is placed in a predetermined position; and
a voice distributing unit configured to distribute each of the voices of the plurality of frequency components so as to be output from any one of the plurality of voice outputting devices on the basis of voice source information identified by the voice source identifying unit.

12. The television device according to claim 11, wherein
the associating unit associates the plurality of areas arranged in descending order of area size with the plurality of frequency components arranged in descending order of spectrum strength.

13. The television device according to claim 12, wherein
the area dividing unit divides the frame into the plurality of areas by a K-means method.

14. The television device according to claim 11, wherein
the depth vector detecting unit calculates a difference between a pixel value at coordinates of a current frame for right eye and a pixel value at the same coordinates of a current frame for left eye to detect the depth vectors.

15. The television device according to claim 14, wherein
the motion vector detecting unit calculates a difference between a pixel value at coordinates of the current frame for right eye or for left eye and a pixel value at the same coordinates in a frame for right eye or for left eye that is one or more frames earlier to detect the motion vectors.
